(19) United States
(12) Patent Application Publication
(10) Pub. No.: US 2024/0223340 A1
(43) Pub. Date: Jul. 4, 2024

(54) RESOURCE AND REPORTING SETTINGS FOR UE INITIATED REPORTING

(71) Applicant: Samsung Electronics Co., Ltd., Suwon-si (KR)

(72) Inventors: Dalin Zhu, Allen, TX (US); Md. Saifur Rahman, Plano, TX (US); Emad Nader Farag, Flanders, NJ (US); Gilwon Lee, McKinney, TX (US); Eko Onggosanusi, Coppell, TX (US)

(21) Appl. No.: 18/542,190

(22) Filed: Dec. 15, 2023

Related U.S. Application Data
(60) Provisional application No. 63/436,032, filed on Dec. 29, 2022.

(51) Int. Cl. H04L 5/00

(52) U.S. Cl. CPC H04L 5/0057

(57) ABSTRACT

Methods and apparatuses for resource and reporting settings. A method performed by a user equipment (UE) includes receiving first information to enable transmission of an indicator indicating transmission of a beam report and transmitting, based on the first information, the indicator. The method further includes receiving second information related to one or more channel state information reference signal (CSI-RS) resources for the beam report; measuring, based on the second information, the one or more CSI-RS resources for the beam report; and transmitting the beam report.

### CROSS-REFERENCE TO RELATED AND CLAIM OF PRIORITY

The present application claims priority under 35 U.S.C. § 119(e) to U.S. Provisional Patent Application No. 63/436,032 filed on Dec. 29, 2022, which is hereby incorporated by reference in its entirety.

### TECHNICAL FIELD

The present disclosure relates generally to wireless communication systems and, more specifically, the present disclosure relates to methods and apparatuses for resource and reporting settings to enable user equipment (UE) initiated reporting.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to resource and reporting settings to enable UE initiated reporting.

In an embodiment, a user equipment (UE) is provided. The UE includes a transceiver configured to receive first information to enable transmission of an indicator indicating transmission of a beam report; transmit, based on the first information, the indicator, and receive second information related to one or more channel state information reference signal (CSI-RS) resources for the beam report. The UE further includes a processor operably coupled with the transceiver. The processor is configured to measure, based on the second information, the one or more CSI-RS resources for the beam report. The transceiver is further configured to transmit the beam report.

In another embodiment, a base station (BS) is provided. The BS includes a processor and a transceiver operably coupled with the processor. The transceiver is configured to transmit first information to enable transmission of an indicator indicating transmission of a beam report, receive, based on the first information, the indicator, transmit second information related to one or more CSI-RS resources for the beam report, and receive the beam report, the beam report based on the one or more CSI-RS resources.

In yet another embodiment, a method performed by a UE is provided. The method includes receiving first information to enable transmission of an indicator indicating transmission of a beam report and transmitting, based on the first information, the indicator. The method further includes receiving second information related to one or more CSI-RS resources for the beam report; measuring, based on the second information, the one or more CSI-RS resources for the beam report; and transmitting the beam report.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of. A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example user equipment (UE) according to embodiments of the present disclosure;

FIGS. 4A and 4B illustrate an example of a wireless transmit and receive paths according to embodiments of the present disclosure;

FIG. 5A illustrates an example of a wireless system according to embodiments of the present disclosure;

FIG. 5B illustrates an example of a multi-beam operation according to embodiments of the present disclosure;

FIG. 6 illustrates an example of a transmitter structure for beamforming according to embodiments of the present disclosure;

FIG. 7 illustrates examples of configuring channel state information (CSI) reporting settings for UE-initiated/triggered reporting according to embodiments of the present disclosure;

FIG. 8 illustrates an example of configuring CSI resource/reporting setting(s) for UE-initiated/triggered reporting according to embodiments of the present disclosure;

FIG. 9 illustrates an example of configuring CSI resource/reporting setting(s) for UE-initiated/triggered reporting according to embodiments of the present disclosure;

FIG. 10 illustrates an example of configuring a CSI resource set for UE-initiated/triggered reporting according to embodiments of the present disclosure;

FIG. 11 illustrates another example of configuring a CSI resource set for UE-initiated/triggered reporting according to embodiments of the present disclosure;

FIG. 12 illustrates a flowchart of an example UE procedure for UE-initiated/triggered reporting based on a report type according to embodiments of the present disclosure;

FIG. 13 illustrates a flowchart of an example UE procedure for UE-initiated/triggered reporting based on another report type according to embodiments of the present disclosure; and

FIG. 14 illustrates a flowchart of an example UE procedure for UE-initiated/triggered reporting based on another report type according to embodiments of the present disclosure.

### DETAILED DESCRIPTION

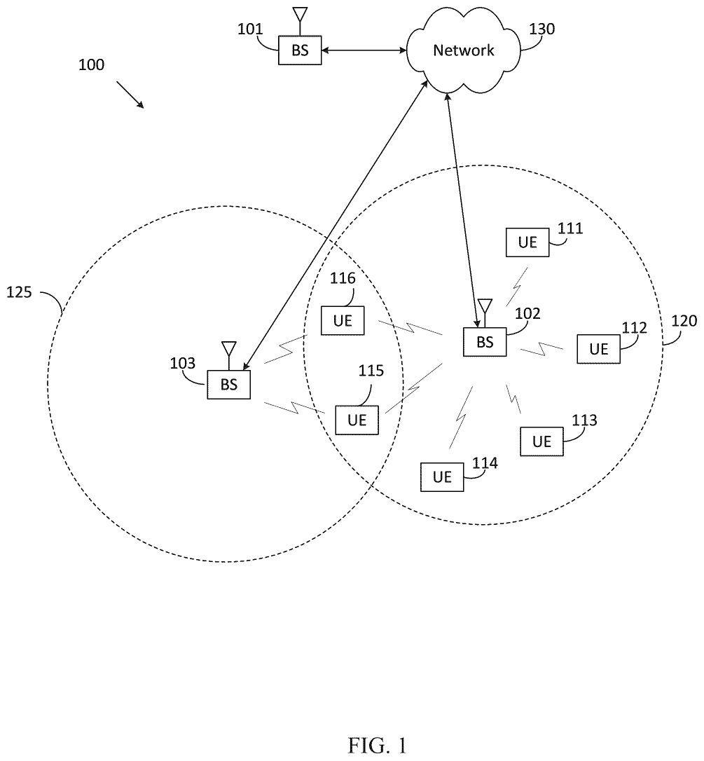

FIGS. 1-14, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: [1] 3GPP TS 38.211 v16.1.0, “NR; Physical channels and modulation;” [2] 3GPP TS 38.212 v16.1.0, “NR; Multiplexing and Channel coding;” [3] 3GPP TS 38.213 v16.1.0, “NR; Physical Layer Procedures for Control;” [4] 3GPP TS 38.214 v16.1.0, “NR; Physical Layer Procedures for Data;” [5] 3GPP TS 38.321 v16.1.0, “NR; Medium Access Control (MAC) protocol specification;” and [6] 3GPP TS 38.331 v16.1.0, “NR; Radio Resource Control (RRC) Protocol Specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, longterm evolution (LTE), longterm evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for identifying and utilizing resource and reporting settings for UE initiated reporting. In certain embodiments, one or more of the BSs 101-103 include circuitry, programing, or a combination thereof to support and enable resource and reporting settings for UE initiated reporting.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

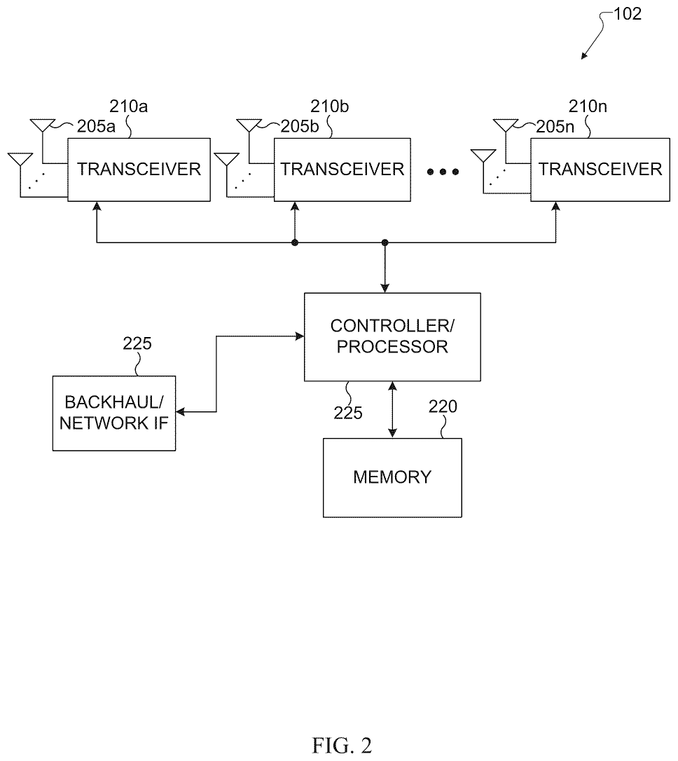

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for supporting and enabling resource and reporting settings for UE initiated reporting. Any of a wide variety of other functions could be supported in the gNB 102 by the controller/processor 225.

The controller/processor 225 is also capable of executing programs and other processes resident in the memory 230, such as processes for supporting and enabling resource and reporting settings for UE initiated reporting. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

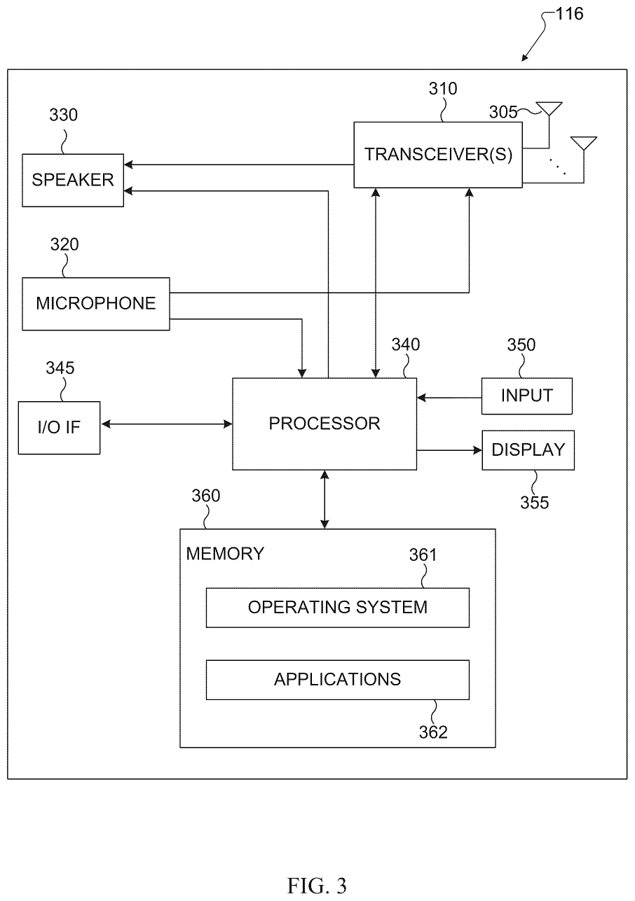

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the ULE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for utilizing resource and reporting settings for UE initiated reporting as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

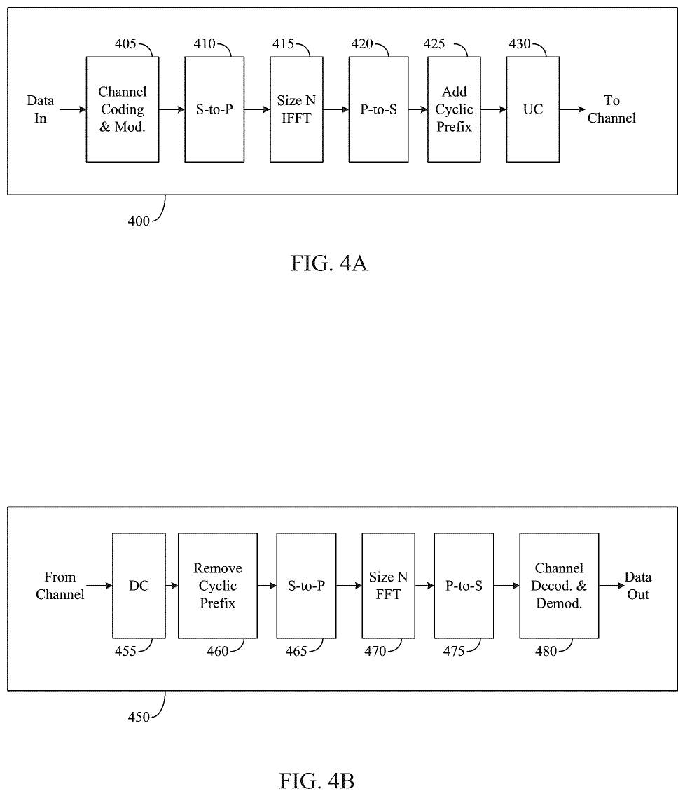

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 and/or the receive path 450 are configured to utilize resource and reporting settings for UE initiated reporting as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 250 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

In embodiments of the present disclosure, a beam is determined by either a transmission configuration indicator (TCI) state that establishes a quasi-colocation (QCL) relationship between a source reference signal (RS) (e.g., single sideband (SSB) and/or Channel State Information Reference Signal (CSI-RS)) and a target RS or a spatial relation information that establishes an association to a source RS, such as SSB or CSI-RS or SRS. In either case, the ID of the source reference signal identifies the beam. The TCI state and/or the spatial relation reference RS can determine a spatial RX filter for reception of downlink channels at the UE 116, or a spatial TX filter for transmission of uplink channels from the UE 116.

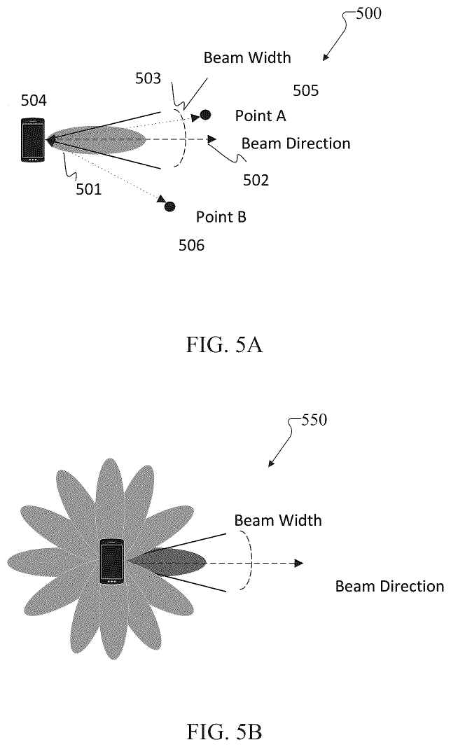

FIG. 5A illustrates an example of a wireless system 500 according to embodiments of the present disclosure. For example, the wireless system 500 can be implemented in the wireless network 100 in FIG. 1. This example is for illustration only and other embodiments can be used without departing from the scope of the present disclosure. As illustrated in FIG. 5A, in a wireless system 500, a beam 501 for a device 504 can be characterized by a beam direction 502 and a beam width 503. For example, the device 504 (or UE 116) transmits RF energy in a beam direction and within a beam width. The device 504 receives RF energy in a beam direction and within a beam width. As illustrated in FIG. 5A, a device at point A 505 can receive from and transmit to device 504 as Point A is within a beam width and direction of a beam from device 504. As illustrated in FIG. 5A, a device at point B 506 cannot receive from and transmit to device 504 as Point B 506 is outside a beam width and direction of a beam from device 504. While FIG. 5A, for illustrative purposes, shows a beam in 2-dimensions (2D), it should be apparent to those skilled in the art, that a beam can be in 3-dimensions (3D), where the beam direction and beam width are defined in space.

FIG. 5B illustrates an example of a multi-beam operation 550 according to embodiments of the present disclosure. For example, the multi-beam operation 550 can be utilized by UE 116 of FIG. 1. This example is for illustration only and other embodiments can be used without departing from the scope of the present disclosure.

In a wireless system, a device can transmit and/or receive on multiple beams. This is known as “multi-beam operation”. While FIG. 5B, for illustrative purposes, a beam is in 2D, it should be apparent to those skilled in the art, that a beam can be 3D, where a beam can be transmitted to or received from any direction in space.

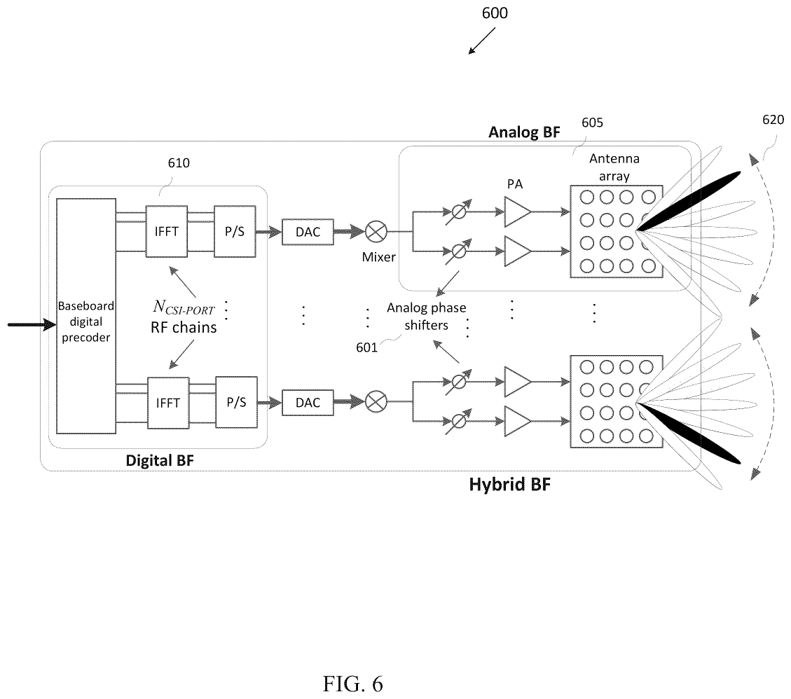

FIG. 6 illustrates an example of a transmitter structure 600 for beamforming according to embodiments of the present disclosure. In certain embodiments, one or more of gNB 102 or UE 116 includes the transmitter structure 600. For example, one or more of antennas 205 and its associated systems or antenna 305 and its associated systems can be included in transmitter structure 600. This example is for illustration only and other embodiments can be used without departing from the scope of the present disclosure.

Accordingly, embodiments of the present disclosure recognize that Rel-14 LTE and Rel-15 NR support up to 32 CSI-RS antenna ports which enable an eNB or a gNB to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 6. Then, one CSI-RS port can be mapped onto a large number of antenna elements that can be controlled by a bank of analog phase shifters 601. One CSI-RS port can then correspond to one sub-array which produces a narrow analog beam through analog beamforming 605. This analog beam can be configured to sweep across a wider range of angles 620 by varying the phase shifter bank across symbols or slots/subframes. The number of sub-arrays (equal to the number of RF chains) is the same as the number of CSI-RS ports N_{CSI-PORT}. A digital beamforming unit 610 performs a linear combination across N_{CSI-PORT} analog beams to further increase a precoding gain. While analog beams are wideband (hence not frequency-selective), digital precoding can be varied across frequency sub-bands or resource blocks. Receiver operation can be conceived analogously.

Since the transmitter structure 600 of FIG. 6 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 6 is also applicable to higher frequency bands such as >52.6 GHz (also termed frequency range 4 or FR4). In this case, the system can employ only analog beams. Due to the O2 absorption loss around 60 GHz frequency (˜10 dB additional loss per 100 m distance), a larger number and narrower analog beams (hence a larger number of radiators in the array) are needed to compensate for the additional path loss.

The text and figures are provided solely as examples to aid the reader in understanding the present disclosure. They are not intended and are not to be construed as limiting the scope of the present disclosure in any manner. Although certain embodiments and examples have been provided, it will be apparent to those skilled in the art based on the disclosures herein that changes in the embodiments and examples shown may be made without departing from the scope of the present disclosure. The transmitter structure 600 for beamforming is for illustration only and other embodiments can be used without departing from the scope of the present disclosure.

The flowcharts herein illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

In (up to Rel.17) NR specification, the most resource-efficient reporting mechanism for a content (e.g., beam, CSI etc., or in general different report quantities) is aperiodic (in conjunction with aperiodic CSI-RS). On the other hand, with a well-chosen periodicity, periodic reporting (followed by semi-persistent) results in the lowest latency at the expense of resources. Although aperiodic reporting seems preferred from the overall operational perspective, in a few relevant scenarios the NW/gNB lacks knowledge on the DL channel condition—or, in other words, the UE knows the DL channel condition better. In this case, it is clearly beneficial if the UE can initiate its own aperiodic reporting for a content (e.g., beam, CSI etc.). For instance, when the UE is configured only with aperiodic beam reporting and the channel condition is worsened to the point of beam failure, the loss of link due to beam failure can be avoided if the UE can transmit an aperiodic beam report without having to wait for a beam report request/trigger from the NW/gNB. Likewise, when the UE is configured only with aperiodic CSI reporting and the channel condition is worsened due to UE speed/movement, the performance degradation due to faster link quality degradation can be avoided if the UE can transmit an aperiodic CSI report without having to wait for a CSI request/trigger from the NW/gNB. Such UE-initiated reporting for a content can be enabled for other types of report quantities (different from traditional beam or CSI reports).

Although UE-initiated reporting can be beneficial, efficient designs are needed to ensure that the latency is reduced and, at the same time, error events can be minimized. Embodiments of the present disclosure recognize there is a need for efficient designs for UE-initiated reporting for a content that can offer good trade-off between latency and reliability. In particular, when the UE-initiated reporting framework can include multiple report types (or report quantities), or/and multiple event types when a report types can be associated with an event (e.g., for beam report, the event can be a beam failure. For CSI, the event can be user throughput degradation or increasing retransmission rate).

This disclosure provides example embodiments on the above mentioned UE-initiated reporting. More specifically, the present disclosure provides various measurement resource/reporting settings/configurations that can enable the UE-initiated or triggered reporting.

The present disclosure provides various novel and detailed resource and reporting settings to enable the UE-initiated/triggered reporting. Furthermore, how a UE would measure (or be configured to measure) the reference signals (RSs) corresponding/associated to the UE-initiated/triggered reporting is specified. Depending on the event type(s), different measurement configurations are specified, and the corresponding UE/NW operations are also provided in the present disclosure.

In the present disclosure, a UE detects (or determines) a need for transmitting a UE-initiated/UE-triggered report (or initiation/triggering) of a (report-)type (A), (B), or (C), where:
(A) includes an initiator/trigger/pre-notification message.
(B) includes a report/content (comprising one or multiple report quantities).
(C) includes both a trigger/pre-notification message and a (corresponding) report/content.

The report is to facilitate/enable efficient/timely/fast/reliable communication over the link/channel between a target entity (e.g., NW/gNB or another device) and the UE. The content (if reported) can include a quantity or quantities. At least one of the following examples can be used/configured for the content.

In one example, the content includes beam-related quantity/quantities. For example, up to N≥1 indicators {I_i} or pairs of {(I_i,J_i)}, where I_i is a beam (source RS) indicator (e.g., CRI, semi-static beam reporting interval (SSBRI)) and J_i is a beam metric (e.g., L1-RSRP, L1-SINR).

In one example, the content includes CSI-related quantity/quantities. For example, at least one of (rank indicator (RI), precoding matrix indicator (PMI), channel quality indicator (CQI), CQI report indicator (CRI), layer index (LI)).

In one example, the content includes transport block data coding payload (TDCP)-related quantity/quantities. For example, an indicator about the Doppler profile (e.g., Doppler spread or Doppler shift, relative Doppler spreads, or relative Doppler shifts), or an indicator about the auto-correlation profiles (e.g. (auto-)correlation values corresponding to a few dominant lags/delays).

In one example, the content includes other (e.g., non-beam, non-CSI, non-TDCP) quantity/quantities.

In one example, quantity/quantities comprise a selector/indicator indicating selection of one (or >1) of either:
beam (TCI state) TCI states (e.g., DL TCI state, UL TCI state, or unified (joint) DL/UL TCI state).
panel(s) (e.g., UE panels for DL reception or/and UL transmission).
antenna(e) (e.g., UE antennae for DL reception or/and UL transmission).
antenna port(s) (e.g., UE antenna ports for DL reception or/and UL transmission).

In one example, quantity/quantities comprise an indicator indicating switching from one beam to another beam, or from one panel to another, or from one antenna port group to another antenna port group, or from N_1 SRS ports to N_2 SRS ports, where N_1≠N_2 (e.g., this switching is for DL reception or/and UL transmission).

In one example, the content includes beam-related quantity/quantities and at least one other quantity/quantities.

In one example, the content includes CSI-related quantity/quantities and at least one other quantity/quantities.

In one example, the content includes TDCP-related quantity/quantities and at least one other quantity/quantities.

In one example, the content includes beam-related quantity/quantities and CSI-related quantity/quantities.

In one example, the content includes beam-related quantity/quantities and TDCP-related quantity/quantities.

In one example, the content includes TDCP-related quantity/quantities and CSI-related quantity/quantities.

In one example, the report is targeting a physical layer (L1) communication (e.g., L1 DL/UL, or L1 SL), i.e., such reporting is to enable fast/reliable DL/UL or SL transmission/reception.

In one example, the link/channel between the target entity and the ULE 116 is a Uu interface (i.e., DL, UL).

In one example, the link/channel between the target entity and the UE 116 is a sidelink (SL), or a device-to-device (D2D) or PC5 interface.

In one example, such reporting can be non-event-based or autonomous, the UE 116 can initiate/trigger the report autonomously (i.e., without being associated with any event) or unconditionally/freely. For example, the UE 116 can be configured with a triggering time window (or multiple UL slots), and the UE 116 can trigger the report during this window.

In one example, such reporting can be event-based, i.e., the UE 116 can initiate/trigger the report only when it detects an event associated with the report, where the event can be of a (event-)type: type 0, type 1, and so on. In one example, type 0 corresponds to a beam-related event, type 1 corresponds to a CSI-related event, type 2 corresponds to a time-domain channel property (TDCP)-related event, and type 3 can be a non-CSI-related event (examples provided later). In one example, if a metric (depending on the event-type) is less than or equal to a threshold (or greater than or equal to a threshold), the event is detected or declared positive. The threshold is chosen such that a failure (e.g., beam/link failure) can be detected before it actually happens, and the UE-initiated report can avoid the failure.

In one example, such reporting can be non-event-based or event-based, based on report-type.

In one example, such reporting can be non-event-based or event-based, based on a configuration.

A few examples of the event-types and the report-types are provided in Table 1 (for joint) and Table 2/Table 3 (for separate). In these examples, the event-types and the report-types are separate (explicit). However, they can also be joint, as shown in Table 4. A few examples of the autonomous UE-initiated report are shown in Table 5.

TABLE 1

| | Report | | |
|---|---|---|---|
| | | Trigger/pre- | |
| Event type | Type | notification message | Content |
| 0: beam | (A) | Yes (e.g., beam- | No |
| | | related event) | |
| | (B) | No | Yes |
| | (C) | Yes (e.g., beam- | Yes |
| | | related event) | |
| 1: CSI | (A) | Yes (e.g., CSI- | No |
| | | related event) | |
| | (B) | No | Yes |
| | (C) | Yes (e.g., CSI- | Yes |
| | | related event) | |
| 2: TDCP | (A) | Yes (e.g., TDCP- | No |
| | | related event) | |
| | (B) | No | Yes |
| | (C) | Yes (e.g., TDCP- | Yes |
| | | related event) | |
| 3: non-CSI/ | (A) | Yes (e.g., non-CSI- | No |
| beam/TDCP | | related event) | |
| | (B) | No | Yes |
| | (C) | Yes (e.g., non-CSI- | Yes |
| | | related event) | |
| 4. other (content- | (A) | Yes (no need for | No |
| free/less events) | | content) | |

TABLE 2

| Event-type | Event |
|---|---|
| 0 | Beam-related |
| 1 | CSI-related |
| 2 | TDCP-related |
| 3 | Non-beam/ |
| | CSI/TDCP |
| 4 | Other |

TABLE 3

| Report- | Trigger/pre- | |
|---|---|---|
| type | notification message | Content |
| (A) | Yes | No |
| (B) | No | Yes |
| (C) | Yes | Yes |

TABLE 4
Report

| Type | Trigger/pre-notification message | Content |
|---|---|---|
| 0 | Yes (e.g., beam-related event), | No |
| | content-specific or event-specific | |
| 1 | No | Beam |
| 2 | Yes (e.g., beam-related event) | Beam |
| 3 | Yes (e.g., CSI-related event) | No |
| 4 | No | CSI |
| 5 | Yes (e.g., CSI-related event) | CSI |
| 6 | Yes (e.g., TDCP-related event) | No |
| 7 | No | TDCP |
| 8 | Yes (e.g., TDCP-related event) | TDCP |
| 9 | Yes (e.g., non-CSI-related event) | No |
| 10 | No | Non-CSI |
| 11 | Yes (e.g., non-CSI-related event) | Non-CSI |

TABLE 5
Report

| | Trigger/pre- | |
|---|---|---|
| Type | notification message | Content |
| 0 | Yes (content- | No |
| | agnostic/transparent) | |
| 1 | No | Beam |
| 2 | Yes | Beam |
| 3 | No | CSI |
| 4 | Yes | CSI |
| 5 | No | TDCP |
| 6 | Yes | TDCP |
| 7 | No | Non-CSI |
| 8 | Yes | Non-CSI |

In one example, an index or a parameter (e.g., reportQuantity) can be used to indicate one example from above tables. The index/parameter can be used to configure the UE-initiated report according to one of the above examples, e.g., via higher layer RRC. Such a configuration can be subject to the UE 116 capability. In one example, the index/parameter can also indicate multiple (e.g., 2) examples from above table. In this case, the UE-initiated report can include the report for at least one for the two.

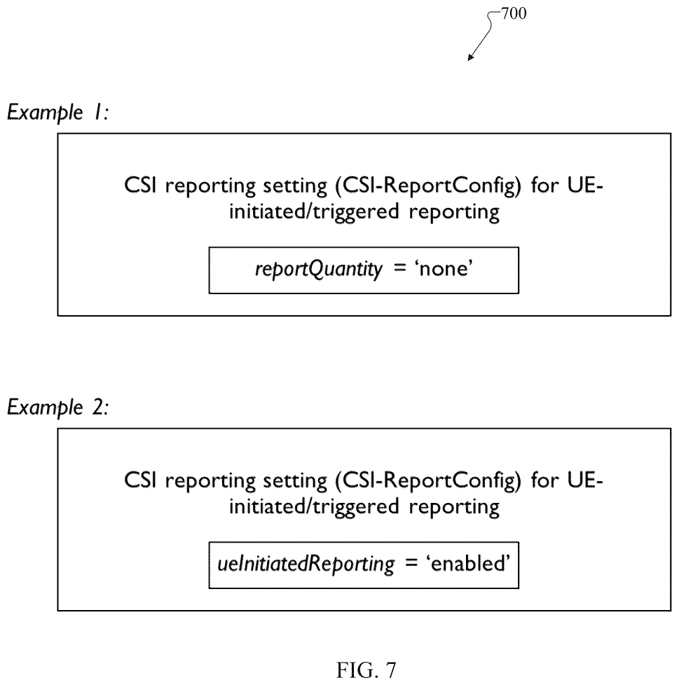

FIG. 7 illustrates examples of configuring CSI reporting settings 700 for UE-initiated/triggered reporting according to embodiments of the present disclosure. For example, CSI reporting settings for UE-initiated/triggered reporting can be provided by the BS 102 of FIG. 1. This example is for illustration only and other embodiments can be used without departing from the scope of the present disclosure.

In this disclosure, the UE-initiated or UE-triggered reporting as specified herein in the present disclosure could be associated with or linked to one or more CSI reporting settings each provided by CSI-ReportConfig.

In one example, the CSI reporting setting ID(s) provided by reportConfigId for the one or more CSI reporting settings for the UE-initiated or UE-triggered reporting could be fixed in the system specification(s)—e.g., corresponding to the lowest/highest or predefined/preconfigured CSI reporting setting ID(s) and known to both the UE 116 and network 130 sides. Alternatively, the UE 116 could be provided/indicated/configured by the network 130, e.g., via higher layer RRC signaling/parameter (e.g., in/via the higher layer RRC parameter CSI-MeasConfig) and/or MAC CE command and/or dynamic DCI based L1 signaling, the CSI reporting setting ID(s)—provided by reportConfigId—for the one or more CSI reporting settings for the UE-initiated or UE-triggered reporting.

In another example, the one or more CSI reporting settings for the UE-initiated or UE-triggered reporting could correspond to the CSI reporting setting(s) with the higher layer parameter ‘reportQuantity’ configured therein set to ‘none’.

In yet another example, a higher layer parameter denoted by ‘ueInitiatedReporting’ could be provided/configured in a CSI reporting setting (e.g., in the corresponding higher layer RRC parameter CSI-ReportConfig). For this case, the one or more CSI reporting settings for the UE-initiated or UE-triggered reporting could correspond to the CSI reporting setting(s) with the higher layer parameter ‘ueInitiatedReporting’ configured therein set to ‘enabled’.

In yet another example, the UE 116 could be provided/configured/indicated by the network 130, e.g., via higher layer RRC signaling/parameter (e.g., in/via the higher layer RRC parameter CSI-MeasConfig) and/or MAC CE command and/or dynamic DCI based L1 signaling, a bitmap with each bit position/entry of the bitmap corresponding/associated to a CSI reporting setting configured therein. When/if a bit position/entry of the bitmap is set to ‘1’ (or ‘0’), the corresponding/associated CSI reporting setting could be enabled for the UE-initiated/triggered reporting.

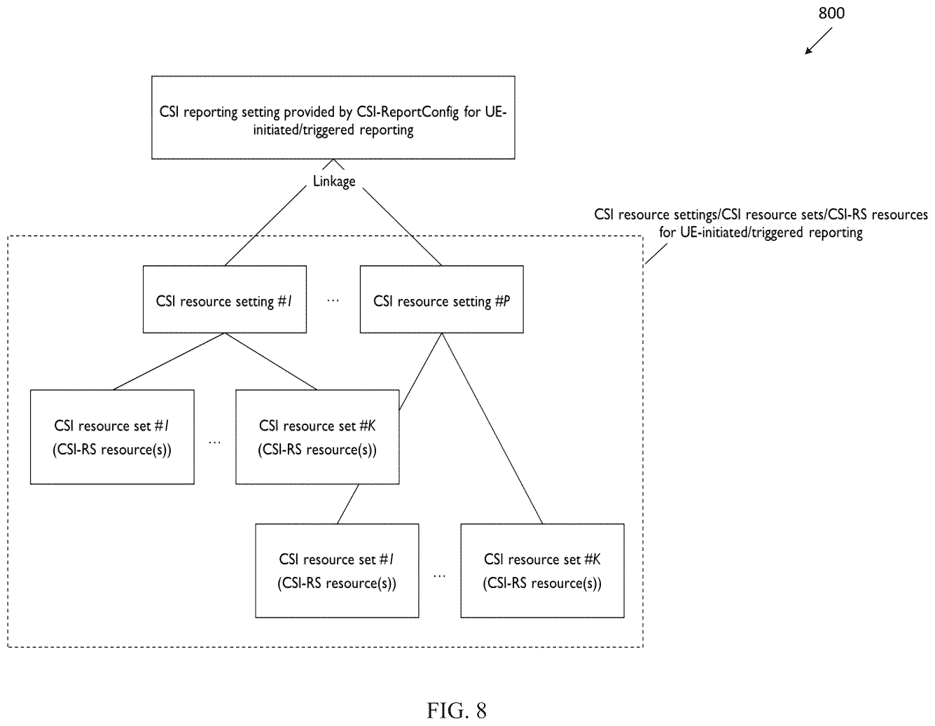

FIG. 8 illustrates an example of configuring CSI resource/reporting setting(s) 800 for UE-initiated/triggered reporting according to embodiments of the present disclosure. For example, CSI resource/reporting setting(s) 800 can be provided by the BS 102 of FIG. 1 and identified and used by the UE 116 of FIG. 1. This example is for illustration only and other embodiments can be used without departing from the scope of the present disclosure.

In the present disclosure, a CSI reporting setting for the UE-initiated/triggered reporting as described herein could be associated with one or more CSI resource settings (each provided by CSI-ResourceConfig). Here, the one or more CSI resource settings could be referred to as CSI resource setting(s) for the UE-initiated/triggered reporting. Each CSI resource setting for the UE-initiated/triggered reporting could comprise one or more CSI resource sets (e.g., SSB resource set(s) provided by CSI-SSB-ResourceSet or non-zero power (NZP) CSI-RS resource set(s) provided by nzp-CSI-RS-ResourceSet). Here, the one or more CSI resource sets could be referred to as CSI resource set(s) for the UE-initiated/triggered reporting. Furthermore, each CSI resource set for the UE-initiated/triggered reporting could comprise one or more CSI-RS resources including SSB resource indexes (each provided by SSB-Index) or one or more NZP CSI-RS resources (each provided by NZP-CSI-RS-Resource) for the UE-initiated/triggered reporting. In the present disclosure, the UE could measure the one or more CSI-RSs for the UE-initiated/triggered reporting (e.g., provided/configured in the CSI resource setting(s)/CSI resource set(s) for the UE-initiated/triggered reporting), and use/apply the corresponding measurement result(s) to autonomously initiate/trigger the event(s)-based or non-event(s)-based reporting as specified herein in the present disclosure. In FIG. 8, an example of the CSI resource setting(s), and therefore the CSI resource set(s) configured therein, for the UE-initiated/triggered reporting is provided. As depicted in FIG. 8, the CSI resource setting(s) for the UE-initiated/triggered reporting is linked/associated to the CSI reporting setting for the UE-initiated/triggered reporting.

In the present disclosure, a CSI reporting setting could be associated with one or more CSI resource settings (each provided by CSI-ResourceConfig), wherein each CSI resource setting could comprise one or more CSI resource sets (e.g., SSB resource set(s) provided by CSI-SSB-ResourceSet or NZP CSI-RS resource set(s) provided by nzp-CSI-RS-ResourceSet) and each CSI resource set could comprise one or more CSI-RS resources including SSB resource indexes (each provided by SSB-Index) or one or more NZP CSI-RS resources (each provided by NZP-CSI-RS-Resource).

In one example, the one or more CSI resource settings could be (enabled) for the UE-initiated/triggered reporting according to one or more of the following.

For example, the CSI resource setting ID(s) provided by csi-ResourceConfigId for the one or more CSI resource settings for the UE-initiated or UE-triggered reporting could be fixed in the system specification(s)—e.g., corresponding to the lowest/highest or predefined/preconfigured CSI resource setting ID(s) and known to both the UE 116 and network 130 sides. Alternatively, the UE 116 could be provided/indicated/configured by the network 130, e.g., via higher layer RRC signaling/parameter (e.g., in/via the higher layer RRC parameter CSI-MeasConfig) and/or MAC CE command and/or dynamic DCI based L1 signaling, the CSI resource setting ID(s)—provided by csi-ResourceConfigId—for the one or more CSI resource settings for the UE-initiated or UE-triggered reporting.

For another example, a higher layer parameter denoted by ‘csiResourceConfigForUeInitiatedReporting’ could be provided/configured in a CSI resource setting (e.g., in the corresponding higher layer RRC parameter CSI-ResourceConfig). For this case, the one or more CSI resource settings for the UE-initiated or UE-triggered reporting could correspond to the CSI resource setting(s) with the higher layer parameter ‘csiResourceConfigForUeInitiatedReporting’ configured therein set to ‘enabled’.

Yet for another example, the UE 116 could be provided/configured/indicated by the network 130, e.g., via higher layer RRC signaling/parameter (e.g., in/via the higher layer RRC parameter CSI-MeasConfig) and/or MAC CE command and/or dynamic DCI based L1 signaling, a bitmap with each bit position/entry of the bitmap corresponding/associated to a CSI resource setting configured therein. When/if a bit position/entry of the bitmap is set to ‘1’ (or ‘0’), the corresponding/associated CSI resource setting could be enabled for the UE-initiated/triggered reporting.

In another example, the one or more CSI resource sets (provided/configured in the one or more CSI resource settings) could be (enabled) for the UE-initiated/triggered reporting according to one or more of the following.

For example, the CSI resource set ID(s) (e.g., provided by csi-SSB-ResourceSetId for a SSB resource set or nzp-CSI-RS-ResourceSetId for a NZP CSI-RS resource set) for the one or more CSI resource sets for the UE-initiated or UE-triggered reporting could be fixed in the system specification(s)—e.g., corresponding to the lowest/highest or predefined/preconfigured CSI resource set ID(s), and known to both the UE 116 and network 130 sides. Alternatively, the UE 116 could be provided/indicated/configured by the network 130, e.g., via higher layer RRC signaling/parameter (e.g., in/via the higher layer RRC parameter CSI-ResourceConfig) and/or MAC CE command and/or dynamic DCI based L1 signaling, the CSI resource set ID(s)—provided by csi-SSB-ResourceSetId for a SSB resource set or nzp-CSI-RS-ResourceSetId for a NZP CSI-RS resource set—for the one or more CSI resource sets for the UE-initiated or UE-triggered reporting.

For another example, a higher layer parameter denoted by ‘csiResourceSetForUeInitiatedReporting’ could be provided/configured in a CSI resource set (e.g., in the corresponding higher layer RRC parameter csi-SSB-ResourceSetId for a SSB resource set or nzp-CSI-RS-ResourceSetId for a NZP CSI-RS resource set). For this case, the one or more CSI resource sets for the UE-initiated or UE-triggered reporting could correspond to the CSI resource set(s) with the higher layer parameter ‘csiResourceSetForUeInitiatedReporting’ configured therein set to ‘enabled’.

Yet for another example, the UE 116 could be provided/configured/indicated by the network 130, e.g., via higher layer RRC signaling/parameter (e.g., in/via the higher layer RRC parameter CSI-ResourceConfig) and/or MAC CE command and/or dynamic DCI based L1 signaling, a bitmap with each bit position/entry of the bitmap corresponding/associated to a CSI resource set configured therein. When/if a bit position/entry of the bitmap is set to ‘1’ (or ‘0’), the corresponding/associated CSI resource set such as SSB resource set or NZP CSI-RS resource set could be enabled for the UE-initiated/triggered reporting.

In yet another example, the one or more CSI-RS resources (provided/configured in the one or more CSI resource sets) could be (enabled) for the UE-initiated/triggered reporting according to one or more of the following.

For example, the CSI-RS resource ID(s) (e.g., provided by SSB-Index for a SSB resource or nzp-CSI-RS-ResourceId for a NZP CSI-RS resource) for the one or more CSI-RS resources for the UE-initiated or UE-triggered reporting could be fixed in the system specification(s)—e.g., corresponding to the lowest/highest or predefined/preconfigured CSI-RS resource ID(s), and known to both the UE 116 and network 130 sides. Alternatively, the UE 116 could be provided/indicated/configured by the network 130, e.g., via higher layer RRC signaling/parameter (e.g., in/via the higher layer RRC parameter CSI-SSB-ResourceSet for a SSB resource set or NZP-CSI-RS-ResourceSet for a NZP CSI-RS resource set) and/or MAC CE command and/or dynamic DCI based L1 signaling, the CSI-RS resource ID(s)—provided by SSB-Index for a SSB resource or nzp-CSI-RS-ResourceId for a NZP CSI-RS resource—for the one or more CSI-RS resources for the UE-initiated or UE-triggered reporting.

For another example, a higher layer parameter denoted by ‘csiResourceForUeInitiatedReporting’ could be provided/configured in a CSI-RS resource (e.g., in the corresponding higher layer RRC parameter SSB-Index for a SSB resource or NZP-CSI-RS-Resource for a NZP CSI-RS resource). For this case, the one or more CSI-RS resources for the UE-initiated or UE-triggered reporting could correspond to the CSI-RS resources with the higher layer parameter ‘csiResourceForUeInitiatedReporting’ configured therein set to ‘enabled’.

Yet for another example, the UE 116 could be provided/configured/indicated by the network 130, e.g., via higher layer RRC signaling/parameter (e.g., in/via the higher layer RRC parameter CSI-SSB-ResourceSet for a SSB resource set or NZP-CSI-RS-ResourceSet for a NZP CSI-RS resource set) and/or MAC CE command and/or dynamic DCI based L1 signaling, a bitmap with each bit position/entry of the bitmap corresponding/associated to a CSI-RS resource configured therein. When/if a bit position/entry of the bitmap is set to ‘1’ (or ‘0’), the corresponding/associated CSI-RS resource such as a SSB resource or a NZP CSI-RS resource could be enabled for the UE-initiated/triggered reporting.

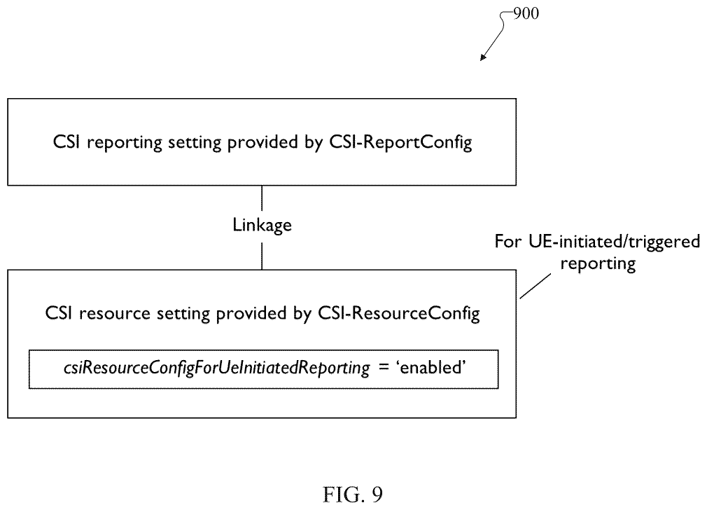

FIG. 9 illustrates an example of configuring CSI resource/reporting setting(s) 900 for UE-initiated/triggered reporting according to embodiments of the present disclosure. For example, CSI resource/reporting setting(s) 900 can be provided by the BS 102 of FIG. 1. This example is for illustration only and other embodiments can be used without departing from the scope of the present disclosure.

As specified herein in the present disclosure, in one embodiment, one or more CSI resource settings could be (enabled) for the UE-initiated/triggered reporting. The UE 116 could measure the CSI-RS(s) configured in the CSI resource setting for the UE-initiated/triggered reporting, and use/apply the corresponding measurement result(s) to autonomously initiate/trigger the event(s)-based or non-event(s)-based reporting as specified herein in the present disclosure.

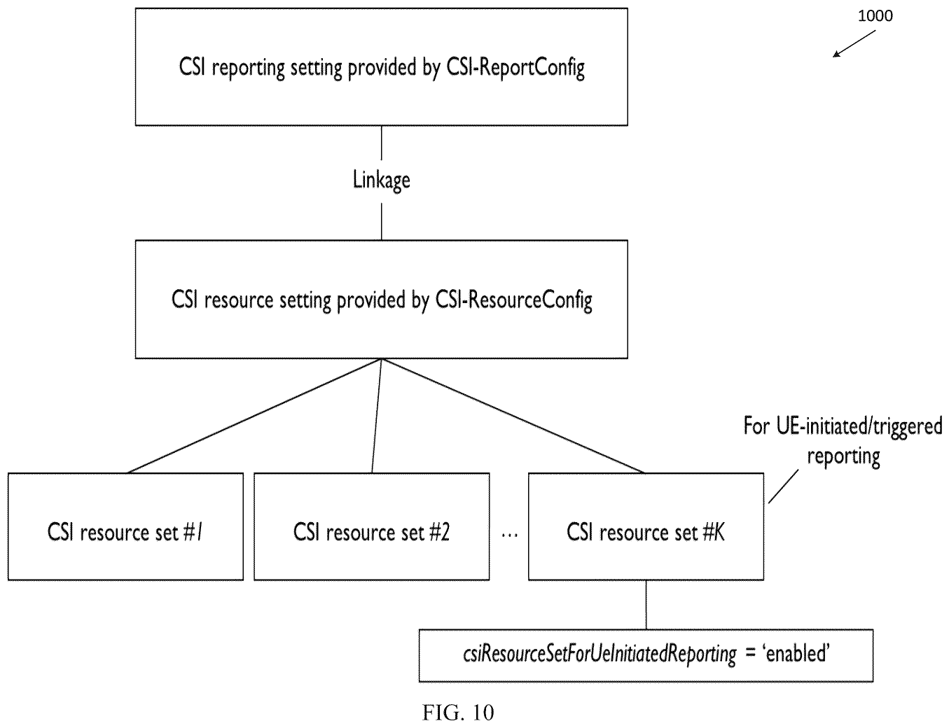

FIG. 10 illustrates an example of configuring a CSI resource set 1000 for UE-initiated/triggered reporting according to embodiments of the present disclosure. For example, CSI resource set 1000 for UE-initiated/triggered reporting can be provided by the BS 102 and utilized by the UE 116. This example is for illustration only and other embodiments can be used without departing from the scope of the present disclosure.

As specified herein in the present disclosure, in one embodiment, one or more CSI resource sets (configured in one or more CSI resource settings) could be (enabled) for the UE-initiated/triggered reporting. The UE 116 could measure the CSI-RS(s) configured in the CSI resource set for the UE-initiated/triggered reporting, and use/apply the corresponding measurement result(s) to autonomously initiate/trigger the event(s)-based reporting as specified herein in the present disclosure.

As specified herein in the present disclosure, in one embodiment, the UE 116 could be configured by the network 130, e.g., via higher layer RRC signaling/parameter (e.g., in a CSI resource set provided by CSI-SSB-ResourceSet or nzp-CSI-RS-ResourceSet) and/or MAC CE command and/or dynamic DCI based L1 signaling, one or more (e.g., N≥1) first reference signals (RSs) or RS resources for beam, channel or interference measurement(s), wherein a first RS could correspond to a SSB (e.g., provided by SSB-Index) or a CSI-RS for tracking, a CSI-RS for CSI acquisition or a CSI-RS for beam management (e.g., provided by NZP-CSI-RS-Resource). Furthermore, the UE 116 could use the measurement results of one or more (e.g., M where 1≤M≤N) of the first RSs—referred to as second RSs in the present disclosure—for the UE-initiated or UE-triggered reporting as specified herein in the present disclosure. As described herein in the present disclosure, the second RSs here can also be referred to as the CSI-RSs or CSI-RS resources (enabled) for the UE-initiated/triggered reporting. For example, the UE 116 could autonomously determine which M second RSs (out of the N first RSs) and, therefore, their corresponding measurement results, to use for the UE-initiated/triggered reporting. For another example, the UE 116 could be indicated/configured/provided by the network 130, e.g., via higher layer RRC signaling/parameter and/or MAC CE command and/or dynamic DCI based L1 signaling, which M second RSs (out of the N first RSs), and therefore, their corresponding measurement results, to use for the UE-initiated/triggered reporting.

In one example, the M second RSs or indexes of the M second RSs—out of the N first RSs—could be fixed in the system specification(s) and known to both the UE 116 and network 130 sides. Specifically, for this design example, the positions/orderings/indexes of the M second RSs in the N first RSs are known to both the UE 116 and network 130 sides.

For example, the M second RSs could correspond to the first (e.g., received or configured to receive earliest in time) M RSs of the N first RSs. For instance, for M=1, the UE 116 could use the first RS (e.g., received or configured to receive earliest in time) of the N first RSs, and, therefore, the corresponding measurement result(s), for the UE-initiated/triggered reporting.

For another example, the M second RSs could correspond to the last (e.g., received or configured to receive latest in time) M RSs of the N first RSs. For instance, for M=1, the UE 116 could use the last RS (e.g., received or configured to receive latest in time) of the N first RSs, and, therefore, the corresponding measurement result(s), for the UE-initiated/triggered reporting.

Yet for another example, the M second RSs could correspond to the M RSs of the N first RSs with the lowest (or highest) RS indexes. For instance, for M=1, the UE 116 could use the RS with the lowest (or highest) RS index of the N first RSs, and, therefore, the corresponding measurement result(s), for the UE-initiated/triggered reporting.

Yet for another example, the M second RSs could correspond to the M RSs of the N first RSs with the lowest (or highest) odd RS indexes. For instance, for M=N, the M second RSs could correspond to all the RSs out of the N first RSs with odd RS indexes.

Yet for another example, the M second RSs could correspond to the M RSs of the N first RSs with the lowest (or highest) even RS indexes. For instance, for M=N, the M second RSs could correspond to all the RSs out of the N first RSs with even RS indexes.

Yet for another example, the M second RSs could correspond to the M RSs of the N first RSs with predefined (odd/even) RS indexes.

Yet for another example, the M second RSs could correspond to the M RSs of the N first RSs with predefined ordering of reception time.

In another example, the M second RSs or indexes of the M second RSs—out of the N first RSs—could be fixed in the system specification(s) and known to both the UE 116 and network 130 sides. Specifically, for this design example, the starting/ending RS index(es) of the M second RSs in the N first RSs are known to both the UE 116 and network 130 sides.

For example, the starting RS could correspond to the first RS (e.g., received or configured to receive earliest in time) of the N first RSs. Alternatively, the starting RS could correspond to the RS of the N first RSs with the lowest (or highest) RS index.

In one example, the M second RSs could correspond to the first M RSs including the starting RS—out of the N first RSs—that are received or configured to receive earliest in time after reception of the starting RS. For instance, for M=1, the UE 116 could use the starting RS, and, therefore, the corresponding measurement result(s), for the UE-initiated/triggered reporting.

In another example, the M second RSs could correspond to the M RSs including the starting RS—out of the N first RSs—that are with the lowest (or highest) RS indexes lower (or higher) than the starting RS index. For instance, for M=1, the UE 116 could use the starting RS, and therefore the corresponding measurement result(s), for the UE-initiated/triggered reporting.

In yet another example, the M second RSs could correspond to the M RSs including the starting RS—out of the N first RSs—that are with the lowest (or highest) odd RS indexes lower (or higher) than the starting RS index. Alternatively, the M second RSs could correspond to the M RSs including the starting RS—out of the N first RSs—that are with the lowest (or highest) even RS indexes lower (or higher) than the starting RS index.

In yet another example, the M second RSs could correspond to the M RSs including the starting RS—out of the N first RSs—that are with predefined ordering of reception time later than the reception of the starting RS. Alternatively, the M second RSs could correspond to the M RSs including the starting RS—out of the N first RSs—that are with predefined (odd/even) RS indexes lower (or higher) than the starting RS index.

For another example, the ending RS could correspond to the last RS (e.g., received or configured to receive latest in time) of the N first RSs. Alternatively, the ending RS could correspond to the RS of the N first RSs with the highest (or lowest) RS index.

In one example, the M second RSs could correspond to the last M RSs including the ending RS—out of the N first RSs—that are received or configured to receive latest in time before reception of the ending RS. For instance, for M=1, the UE 116 could use the ending RS, and therefore the corresponding measurement result(s), for the UE-initiated/triggered reporting.

In another example, the M second RSs could correspond to the M RSs including the ending RS—out of the N first RSs—that are with the highest (or lowest) RS indexes higher (or lower) than the ending RS index. For instance, for M=1, the UE 116 could use the ending RS, and therefore the corresponding measurement result(s), for the UE-initiated/triggered reporting.

In yet another example, the M second RSs could correspond to the M RSs including the ending RS—out of the N first RSs—that are with the highest (or lowest) odd RS indexes higher (or lower) than the ending RS index. Alternatively, the M second RSs could correspond to the M RSs including the ending RS—out of the N first RSs—that are with the highest (or lowest) even RS indexes higher (or lower) than the ending RS index.

In yet another example, the M second RSs could correspond to the M RSs including the ending RS—out of the N first RSs—that are with predefined ordering of reception time earlier than the reception of the ending RS. Alternatively, the M second RSs could correspond to the M RSs including the ending RS—out of the N first RSs—that are with predefined (odd/even) RS indexes higher (or lower) than the ending RS index.

Yet for another example, the starting/ending RS could correspond to a predefined RS index out of the N first RSs. Alternatively, the starting/ending RS could correspond to a RS out of the N first RSs that is received or configured to receive in a predefined reception time. For this case, the M second RSs could be determined according to one or more examples described herein.

In yet another example, the M second RSs or indexes of the M second RSs—out of the N first RSs—could be fixed in the system specification(s) and known to both the UE 116 and network 130 sides. Specifically, for this design example, information of the M second RSs such as a time window/duration for the M second RSs including the starting/ending RS and/or the number of the second RSs (i.e., M in this design example) and/or etc. are known to both the UE 116 and network 130 sides. For this case, the starting/ending RS and/or the M second RSs and/or etc. of the time window/duration for the M second RSs (and therefore, the corresponding information) could be determined according to one or more examples described herein.

In yet another example, the UE 116 could be provided/indicated/configured by the network 130, e.g., via higher layer RRC signaling/parameter (e.g., via a CSI resource/reporting setting) and/or MAC CE command and/or dynamic DCI based L1 signaling, the positions/orderings/indexes of the M second RSs in the N first RSs as described/specified herein in the present disclosure, and/or the starting/ending RS index(es) of the M second RSs in the N first RSs as described/specified herein in the present disclosure and/or the information of the M second RSs such as the time window/duration for the M second RSs including the starting/ending RS and/or the number of the second RSs (i.e., M in this design example) and/or etc. as described/specified herein in the present disclosure, and/or etc.

For example, the RS index(es) of the M second RSs (e.g., provided by SSB-Index for a SSB resource or nzp-CSI-RS-ResourceId for a NZP CSI-RS resource) in the N first RSs could be fixed in the system specification(s)—e.g., corresponding to the lowest/highest or predefined/preconfigured RS index(es) and known to both the UE 116 and network 130 sides. Alternatively, the UE 116 could be provided/indicated/configured by the network 130, e.g., via higher layer RRC signaling/parameter (e.g., in/via the higher layer RRC parameter CSI-SSB-ResourceSet for a SSB resource set or NZP-CSI-RS-ResourceSet for a NZP CSI-RS resource set) and/or MAC CE command and/or dynamic DCI based L1 signaling, the RS index(es) of the M second RSs—provided by SSB-Index for a SSB resource or nzp-CSI-RS-ResourceId for a NZP CSI-RS resource—in the N first RSs.

For another example, a higher layer parameter denoted by ‘csiResourceForUeInitiatedReporting’ could be provided/configured in the configuration of a RS resource (e.g., in the corresponding higher layer RRC parameter SSB-Index for a SSB resource or NZP-CSI-RS-Resource for a NZP CSI-RS resource). For this case, the second RSs (or second RS resources) could correspond to the RS resources with the higher layer parameter ‘csiResourceForUeInitiatedReporting’ configured therein set to ‘enabled’.

Yet for another example, the UE 116 could be provided/configured/indicated by the network 130, e.g., via higher layer RRC signaling/parameter (e.g., in/via the higher layer RRC parameter CSI-SSB-ResourceSet for a SSB resource set or NZP-CSI-RS-ResourceSet for a NZP CSI-RS resource set) and/or MAC CE command and/or dynamic DCI based L1 signaling, a bitmap with each bit position/entry of the bitmap corresponding/associated to a first RS or RS resource configured therein. When/if a bit position/entry of the bitmap is set to ‘1’ (or ‘0’), the corresponding/associated first RS or RS resource such as a SSB resource or a NZP CSI-RS resource could be enabled as a second RS or RS resource for the UE-initiated/triggered reporting.

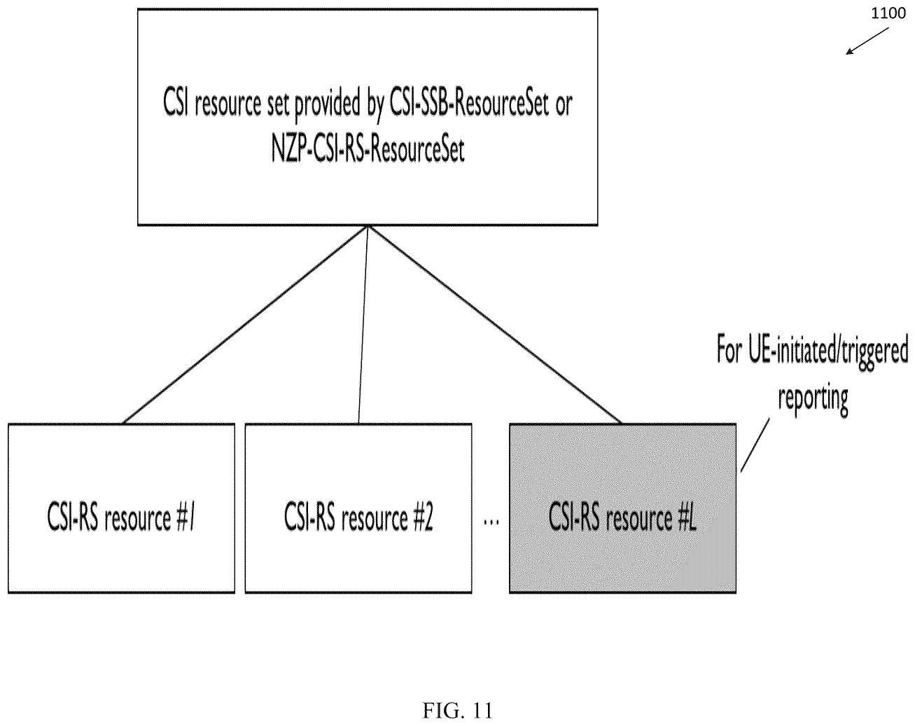

FIG. 11 illustrates another example of configuring a CSI resource set 1100 for UE-initiated/triggered reporting according to embodiments of the present disclosure. For example, CSI resource set 1100 for UE-initiated/triggered reporting can be provided by the BS 102 of FIG. 1 and utilized by the UE 116. This example is for illustration only and other embodiments can be used without departing from the scope of the present disclosure.

With reference to FIG. 11, an example of the second RS(s) or RS resource(s), or equivalently, the CSI-RS resource(s) for the UE-initiated/triggered reporting is shown. The UE 116 could measure the CSI-RS(s) for the UE-initiated/triggered reporting and use/apply the corresponding measurement result(s) to autonomously initiate/trigger the event(s)-based or non-event(s)-based reporting as specified herein in the present disclosure.

In the present disclosure, the UE 116 could be provided/configured/indicated by the network 130, e.g., via higher layer RRC signaling/parameter and/or MAC CE command and/or dynamic DCI based L1 signaling, whether the UE-initiated or UE-triggered reporting is enabled or not. For instance, a higher layer RRC parameter denoted by ueInitiatedReporting could be provided/configured in PDSCH-Config, PDCCH-Config, ControlResourceSet, CSI-ReportConfig, CSI-ResourceConfig, etc. When/if the higher layer parameter ueInitiatedReporting is set to enabled, the UE 116 could measure the CSI-RS(s) for the UE-initiated/triggered reporting determined according to one or more examples described herein and use/apply the corresponding measurement result(s) to autonomously initiate/trigger the event(s)-based or non-event(s)-based reporting as specified herein in the present disclosure. In addition, the CSI resource setting(s)—and, therefore, the corresponding CSI resource set(s) and CSI-RS resource(s) configured therein—for the UE-initiated/triggered reporting could be configured or received or configured to receive the latest in time (e.g., in the latest or most recent slot). Furthermore, the CSI resource setting(s)—and, therefore, the corresponding CSI resource set(s) and CSI-RS resource(s) configured therein—for the UE-initiated/triggered reporting could be configured with ‘resourceType’ set to ‘aperiodic’, ‘semiPersistent’ or ‘periodic’.

For aperiodic CSI for the UE-initiated or UE-triggered reporting, and for periodic, semi-persistent and aperiodic CSI resource settings, each trigger state configured using the higher layer parameter CSI-AperiodicTriggerState could be associated with one or multiple CSI reporting settings each provided by CSI-ReportConfig, wherein:
The one or multiple CSI reporting settings could correspond to the CSI reporting setting(s) for the UE-initiated/triggered reporting determined according to one or more examples described herein—e.g., the CSI reporting setting(s) with the higher layer parameter ‘reportQuantity’ configured therein set to ‘none’, or with the higher layer parameter ‘ueInitiatedReporting’ configured therein set to ‘enabled’.
The one or multiple CSI reporting settings could be linked to one or more CSI resource settings for the UE-initiated/triggered reporting determined according to one or more examples described herein—e.g., the CSI resource setting(s) with the higher layer parameter ‘csiResourceConfigForUeInitiatedReporting’ set to ‘enabled’.
The one or multiple CSI reporting settings could be linked to one or more CSI resource settings, wherein the CSI resource setting(s) could comprise one or more CSI resource sets for the UE-initiated/triggered reporting determined according to one or more examples described herein—e.g., the CSI resource set(s) with the higher layer parameter ‘csiResourceSetForUeInitiatedReporting’ set to ‘enabled’.
The one or multiple CSI reporting settings could be linked to one or more CSI resource settings and, therefore, the corresponding CSI resource set(s) configured therein, wherein a CSI resource set could comprise one or more CSI-RS resources for the UE-initiated/triggered reporting determined according to one or more examples described herein.

For aperiodic CSI for the UE-initiated or UE-triggered reporting, and for aperiodic CSI resource settings, each trigger state configured using the higher layer parameter CSI-AperiodicTriggerState could be associated with one or multiple CSI reporting settings each provided by CSI-ReportConfig, wherein the one or multiple CSI reporting settings could be associated with resourcesForUeInitiatedReporting, wherein:
The resourcesForUeInitiatedReporting could correspond to a CSI resource set (enabled) for the UE-initiated/triggered reporting determined according one or more examples described herein—e.g., the CSI resource set with the higher layer parameter ‘csiResourceSetForUeInitiatedReporting’ set to ‘enabled’.
The resourcesForUeInitiatedReporting could correspond to or comprise one or more CSI-RS resources for the UE-initiated/triggered reporting determined according to one or more examples described herein.
The resourcesForUeInitiatedReporting could provide one or more CSI-RS resources (e.g., SSB resources each provided by SSB-Index or NZP CSI-RS resources each provided by NZP-CSI-RS-Resource). The UE 116 could measure the one or more CSI-RS resources provided/configured in resourcesForUeInitiatedReporting and use/apply the corresponding measurement result(s) to autonomously initiate/trigger the event(s)-based or non-event(s)-based reporting as specified herein in the present disclosure.

For the (report-)type (A) specified herein in the present disclosure, a report could only contain/include a trigger/pre-notification message.

In one example, the UE 116 may not measure any RSs or may not be configured to measure any RSs or may not use/apply any measurement results for the (report-)type (A).

In another example, the UE 116 could measure the RSs determined according to the CSI resource setting(s)/CSI resource set(s)/CSI-RS resource(s) linked to the CSI reporting setting(s) for the UE-initiated/triggered reporting determined according to one or more examples described herein—e.g., the CSI reporting setting(s) with the higher layer parameter ‘reportQuantity’ configured therein set to ‘none’, or with the higher layer parameter ‘ueInitiatedReporting’ configured therein set to ‘enabled’. The UE 116 could then apply/use the corresponding measurement result(s) to autonomously initiate/trigger the (report-)type (A) based reporting as specified herein in the present disclosure.

In yet another example, the UE 116 could measure the RSs determined according to the CSI resource setting(s) for the UE-initiated/triggered reporting determined according to one or more examples described herein—e.g., the CSI resource setting(s) with the higher layer parameter ‘csiResourceConfigForUeInitiatedReporting’ set to ‘enabled’. The UE 116 could then apply/use the corresponding measurement result(s) to autonomously initiate/trigger the (report-)type (A) based reporting as specified herein in the present disclosure.

In yet another example, the UE 116 could measure the RSs determined according to the CSI resource set(s) for the UE-initiated/triggered reporting determined according to one or more examples described herein—e.g., the CSI resource set(s) with the higher layer parameter ‘csiResourceSetForUeInitiatedReporting’ set to ‘enabled’. The UE 116 could then apply/use the corresponding measurement result(s) to autonomously initiate/trigger the (report-)type (A) based reporting as specified herein in the present disclosure.

In yet another example, the UE 116 could measure the RSs determined according to the CSI-RS resource(s) for the UE-initiated/triggered reporting determined according to one or more examples described herein. The UE 116 could then apply/use the corresponding measurement result(s) to autonomously initiate/trigger the (report-)type (A) based reporting as specified herein in the present disclosure.

In yet another example, the UE 116 could measure the RSs determined according to the CSI-RS resource(s) configured/provided by resourcesForUeInitiatedReporting configured/provided in the higher layer parameter CSI-AperiodicTriggerState as specified herein in the present disclosure. The UE 116 could then apply/use the corresponding measurement result(s) to autonomously initiate/trigger the (report-)type (A) based reporting as specified herein in the present disclosure.

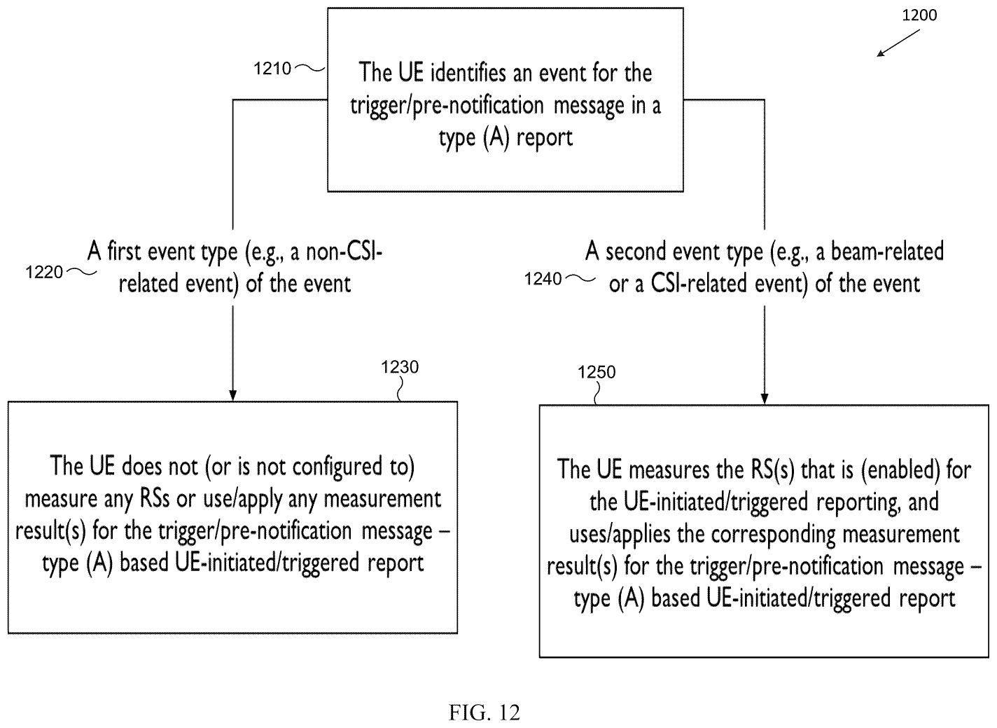

FIG. 12 illustrates a flowchart of an example UE procedure 1200 for UE-initiated/triggered reporting based on a report type according to embodiments of the present disclosure. For example, procedure 1200 for UE-initiated/triggered reporting can be performed by any of the UEs 111-116 of FIG. 1. This example is for illustration only and other embodiments can be used without departing from the scope of the present disclosure.

The procedure begins in 1210, the UE 116 identifies an event for the trigger/pre-notification message in a type (A) report. In one example, the condition(s) could correspond to event-type(s) as specified herein in the present disclosure. For instance, in 1220 for a first event-type (e.g., a non-CSI-related event as specified herein in the present disclosure), the UE 116, in 1230, may not measure any RSs or may not be configured to measure any RSs or may not use/apply any measurement results for the (report-)type (A) based UE-initiated/triggered reporting (i.e., one or more examples described herein). In 1240, for a second event-type (e.g., a beam-related or a CSI-related event as specified herein in the present disclosure), the UE 116, in 1250, could follow one or more examples described herein to measure the RS(s) that is (enabled) for the UE-initiated/triggered reporting, and use/apply the corresponding measurement result(s) for the (report-)type (A) based UE-initiated/triggered reporting.

For the (report-)type (A) specified herein in the present disclosure, wherein a report could only contain/include a trigger/pre-notification message, the UE 116 could follow one or more examples described herein to measure or not to measure the RS(s)—e.g., enabled for the UE-initiated/triggered reporting—depending on one or more conditions.

In another example, the condition(s) could correspond to network's configuration(s)/indication(s). For example, the UE 116 could be configured/indicated by the network 130, e.g., via higher layer RRC signaling/parameter and/or MAC CE command and/or dynamic DCI based L1 signaling, not to measure any RSs or not to use/apply any measurement results for the (report-)type (A) based UE-initiated/triggered reporting (i.e., follow one or more examples described herein). For another example, the UE 116 could be configured/indicated by the network 130, e.g., via higher layer RRC signaling/parameter and/or MAC CE command and/or dynamic DCI based L1 signaling, to follow one or more examples described herein to measure the RS(s) that is (enabled) for the UE-initiated/triggered reporting, and use/apply the corresponding measurement result(s) for the (report-)type (A) based UE-initiated/triggered reporting.

For the (report-)type (A) specified herein in the present disclosure, wherein a report could only contain/include a trigger/pre-notification message, the corresponding measurement RS(s) could be with certain RS configuration(s)/setting(s).

In one example, the RS configuration(s)/setting(s) could correspond to a (network) configured or fixed (or predefined) resource mapping for the corresponding measurement RS(s)—e.g., provided in/by CSI-RS-ResourceMapping, wherein the higher layer parameter nrofPorts could be set to ‘p1’—i.e., 1-port CSI-RS for measurement.

In another example, the RS configuration(s)/setting(s) could identify/indicate a resource type, e.g., ‘aperiodic’, ‘semiPersistent’ or ‘periodic’, for the corresponding measurement RS(s).

In yet another example, the RS configuration(s)/setting(s) could identify/indicate a function for the corresponding measurement RS(s)—e.g., the RS configuration(s)/setting(s) could identify/indicate that the corresponding measurement RS(s) is CSI-RS(s) for tracking.

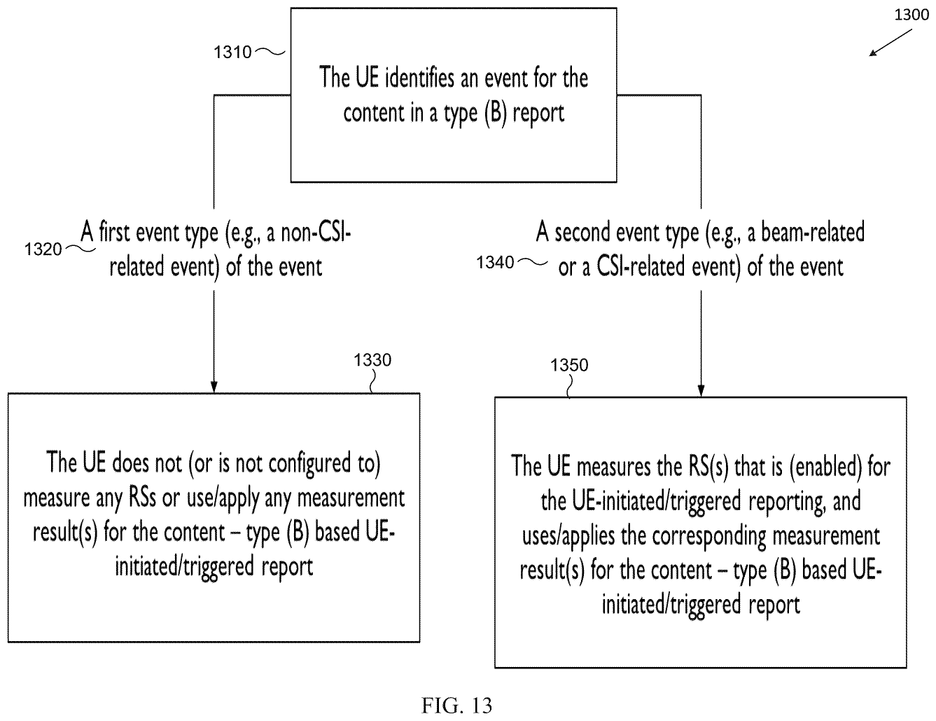

FIG. 13 illustrates a flowchart of an example UE procedure 1300 for UE-initiated/triggered reporting based on another report type according to embodiments of the present disclosure. For example, procedure 1300 for UE-initiated/triggered reporting can be performed by any of the UEs 111-116 of FIG. 1. This example is for illustration only and other embodiments can be used without departing from the scope of the present disclosure.

The procedure begins in 1310, the UE 116 identifies an event for the content in a type (B) report. In one example, the condition(s) could correspond to event-type(s) as specified herein in the present disclosure. For instance, in 1320, for a first event-type (e.g., a non-CSI-related event as specified herein in the present disclosure), the UE 116, in 1330, may not measure any RSs or may not be configured to measure any RSs or may not use/apply any measurement results for the (report-)type (B) based UE-initiated/triggered reporting (i.e., follow one or more examples described herein). In 1340, for a second event-type (e.g., a beam-related or a CSI-related event as specified herein in the present disclosure), the UE 116, in 1350, could follow one or more examples described herein to measure the RS(s) that is (enabled) for the UE-initiated/triggered reporting, and use/apply the corresponding measurement result(s) for the (report-)type (B) based UE-initiated/triggered reporting.

For the (report-)type (B) specified herein in the present disclosure, a report could only contain/include a content (comprising one or more report quantities).

In one example, the UE 116 may not measure any RSs or may not be configured to measure any RSs or may not use/apply any measurement results for the (report-)type (B).

In another example, the UE 116 could measure the RSs determined according to the CSI resource setting(s)/CSI resource set(s)/CSI-RS resource(s) linked to the CSI reporting setting(s) for the UE-initiated/triggered reporting determined according to one or more examples described herein—e.g., the CSI reporting setting(s) with the higher layer parameter ‘reportQuantity’ configured therein set to ‘none’, or with the higher layer parameter ‘ueInitiatedReporting’ configured therein set to ‘enabled’. The UE 116 could then apply/use the corresponding measurement result(s) to autonomously initiate/trigger the (report-)type (B) based reporting as specified herein in the present disclosure.

In yet another example, the UE 116 could measure the RSs determined according to the CSI resource setting(s) for the UE-initiated/triggered reporting determined according to one or more examples described herein—e.g., the CSI resource setting(s) with the higher layer parameter ‘csiResourceConfigForUeInitiatedReporting’ set to ‘enabled’. The UE 116 could then apply/use the corresponding measurement result(s) to autonomously initiate/trigger the (report-)type (B) based reporting as specified herein in the present disclosure.

In yet another example, the UE 116 could measure the RSs determined according to the CSI resource set(s) for the UE-initiated/triggered reporting determined according to one or more examples described herein—e.g., the CSI resource set(s) with the higher layer parameter ‘csiResourceSetForUeInitiatedReporting’ set to ‘enabled’. The UE 116 could then apply/use the corresponding measurement result(s) to autonomously initiate/trigger the (report-)type (B) based reporting as specified herein in the present disclosure.

In yet another example, the UE 116 could measure the RSs determined according to the CSI-RS resource(s) for the UE-initiated/triggered reporting determined according to one or more examples described herein. The UE 116 could then apply/use the corresponding measurement result(s) to autonomously initiate/trigger the (report-)type (B) based reporting as specified herein in the present disclosure.

In yet another example, the UE 116 could measure the RSs determined according to the CSI-RS resource(s) configured/provided by resourcesForUeInitiatedReporting configured/provided in the higher layer parameter CSI-AperiodicTriggerState as specified herein in the present disclosure. The UE 116 could then apply/use the corresponding measurement result(s) to autonomously initiate/trigger the (report-)type (B) based reporting as specified herein in the present disclosure.

For the (report-)type (B) specified herein in the present disclosure, wherein a report could only contain/include a content (comprising one or more report quantities), the UE 116 could follow one or more examples described herein to measure or not to measure the RS(s)—e.g., enabled for the UE-initiated/triggered reporting—depending on one or more conditions.

In another example, the condition(s) could correspond to network's configuration(s)/indication(s). For example, the UE 116 could be configured/indicated by the network 130, e.g., via higher layer RRC signaling/parameter and/or MAC CE command and/or dynamic DCI based L1 signaling, not to measure any RSs or not to use/apply any measurement results for the (report-)type (B) based UE-initiated/triggered reporting (i.e., follow one or more examples described herein). For another example, the UE 116 could be configured/indicated by the network 130, e.g., via higher layer RRC signaling/parameter and/or MAC CE command and/or dynamic DCI based L1 signaling, to follow one or more examples described herein to measure the RS(s) that is (enabled) for the UE-initiated/triggered reporting and use/apply the corresponding measurement result(s) for the (report-)type (B) based UE-initiated/triggered reporting.

For the (report-)type (B) specified herein in the present disclosure, wherein a report could only contain/include a content (comprising one or more report quantities), the corresponding measurement RS(s) could be with certain RS configuration(s)/setting(s).

In one example, the RS configuration(s)/setting(s) could correspond to a (network) configured or fixed (or predefined) resource mapping for the corresponding measurement RS(s)—e.g., provided in/by CSI-RS-ResourceMapping, wherein the higher layer parameter nrofPorts could be set to ‘p2’ or beyond—i.e., x-port CSI-RS for measurement, where x≥2.

In another example, the RS configuration(s)/setting(s) could identify/indicate a resource type, e.g., ‘aperiodic’, ‘semiPersistent’ or ‘periodic’, for the corresponding measurement RS(s).

In yet another example, the RS configuration(s)/setting(s) could identify/indicate a function for the corresponding measurement RS(s)—e.g., the RS configuration(s)/setting(s) could identify/indicate that the corresponding measurement RS(s) is CSI-RS(s) for beam management or CSI-RS(s) for CSI acquisition.

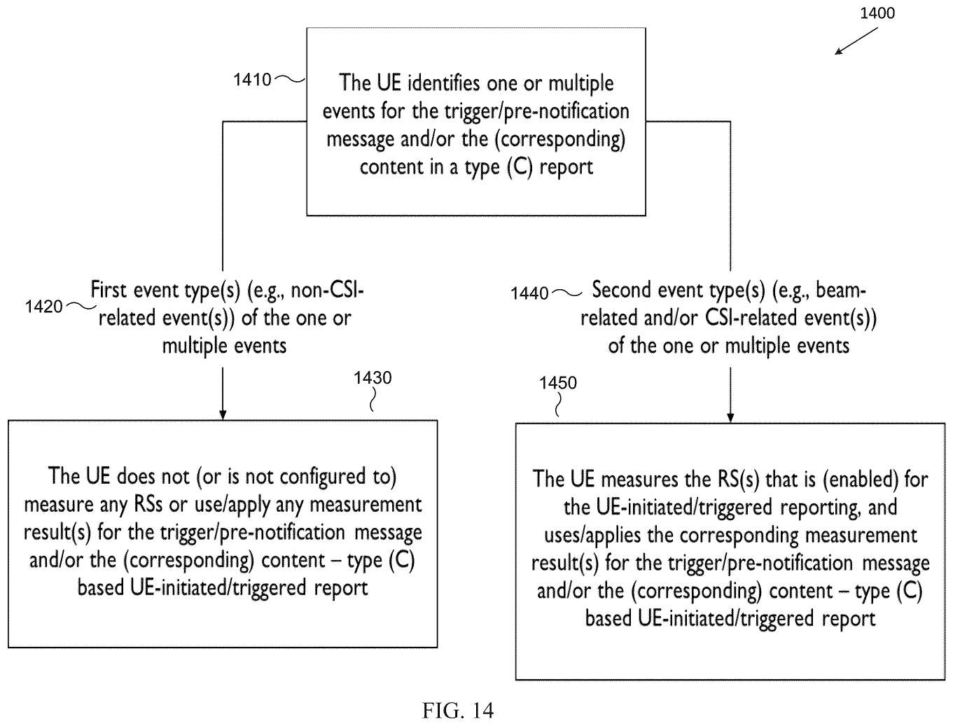

FIG. 14 illustrates a flowchart of an example UE procedure for UE-initiated/triggered reporting based on another report type according to embodiments of the present disclosure. For example, procedure 1400 for UE-initiated/triggered reporting can be performed by the UE 116 of FIG. 3. This example is for illustration only and other embodiments can be used without departing from the scope of the present disclosure.

The procedure begins in 1410, the UE identifies one or multiple events for the trigger/pre-notification message and/or the (corresponding) content in a type (C) report. In one example, the condition(s) could correspond to event-type(s) as specified herein in the present disclosure. For instance, in 1420, for one or more first event-types (e.g., one or more non-CSI-related events as specified herein in the present disclosure), the UE, in 1430, may not measure any RSs or may not be configured to measure any RSs or may not use/apply any measurement results for the trigger/pre-notification message and/or the content in the (report-)type (C) based UE-initiated/triggered report (i.e., follow one or more examples described herein). In 1440, for one or more second event-types (e.g., one or more beam-related or one or more CSI-related events as specified herein in the present disclosure), the UE, in 1450, could follow one or more examples described herein to measure the RS(s) that is (enabled) for the UE-initiated/triggered reporting for the trigger/pre-notification message and/or the content in the (report-)type (C) based report, and use/apply the corresponding measurement result(s) to send the trigger/pre-notification message and/or the content in the (report-)type (C) based UE-initiated/triggered report.

For the (report-)type (C) specified herein in the present disclosure, a report could contain/include a trigger/pre-notification message and a (corresponding) content (comprising one or more report quantities).

In one example, the UE may not measure any RSs or may not be configured to measure any RSs or may not use/apply any measurement results for the trigger/pre-notification message and/or the content in the (report-)type (C) based report.

In another example, the UE could measure the RSs determined according to the CSI resource setting(s)/CSI resource set(s)/CSI-RS resource(s) linked to the CSI reporting setting(s) for the UE-initiated/triggered reporting determined according to one or more examples described herein—e.g., the CSI reporting setting(s) with the higher layer parameter ‘reportQuantity’ configured therein set to ‘none’, or with the higher layer parameter ‘ueInitiatedReporting’ configured therein set to ‘enabled’ for the trigger/pre-notification message and/or the content in the (report-)type (C) based report. The UE could then apply/use the corresponding measurement result(s) to autonomously send the trigger/pre-notification message and/or the content in the (report-)type (C) based report as specified herein in the present disclosure. In this design example, the CSI reporting setting(s) for the UE-initiated/triggered reporting (and, therefore, the linked CSI resource setting(s)/CSI resource set(s)/CSI-RS resource(s)) could be common or different for the trigger/pre-notification message and the content in the (report-)type (C) based report.

In yet another example, the UE could measure the RSs determined according to the CSI resource setting(s) for the UE-initiated/triggered reporting determined according to one or more examples described herein—e.g., the CSI resource setting(s) with the higher layer parameter ‘csiResourceConfigForUeInitiatedReporting’ set to ‘enabled’ for the trigger/pre-notification message and/or the content in the (report-)type (C) based report. The UE could then apply/use the corresponding measurement result(s) to autonomously send the trigger/pre-notification message and/or the content in the (report-)type (C) based report as specified herein in the present disclosure. In this design example, the CSI resource setting(s) for the UE-initiated/triggered reporting could be common or different for the trigger/pre-notification message and the content in the (report-)type (C) based report.

In yet another example, the UE could measure the RSs determined according to the CSI resource set(s) for the UE-initiated/triggered reporting determined according to one or more examples described herein—e.g., the CSI resource set(s) with the higher layer parameter ‘csiResourceSetForUeInitiatedReporting’ set to ‘enabled’ for the trigger/pre-notification message and/or the content in the (report-)type (C) based report. The UE could then apply/use the corresponding measurement result(s) to autonomously send the trigger/pre-notification message and/or the content in the (report-)type (C) based report as specified herein in the present disclosure. In this design example, the CSI resource set(s) for the UE-initiated/triggered reporting could be common or different for the trigger/pre-notification message and the content in the (report-)type (C) based report.

In yet another example, the UE could measure the RSs determined according to the CSI-RS resource(s) for the UE-initiated/triggered reporting determined according to one or more examples described herein for the trigger/pre-notification message and/or the content in the (report-)type (C) based report. The UE could then apply/use the corresponding measurement result(s) to autonomously send the trigger/pre-notification message and/or the content in the (report-)type (C) based report as specified herein in the present disclosure. In this design example, the CSI-RS resource(s) for the UE-initiated/triggered reporting could be common or different for the trigger/pre-notification message and the content in the (report-)type (C) based report.

In yet another example, the UE could measure the RSs determined according to the CSI-RS resource(s) configured/provided by resourcesForUeInitiatedReporting configured/provided in the higher layer parameter CSI-AperiodicTriggerState as specified herein in the present disclosure for the trigger/pre-notification message and/or the content in the (report-)type (C) based report; the UE could then apply/use the corresponding measurement result(s) to autonomously send the trigger/pre-notification message and/or the content in the (report-)type (C) based report as specified herein in the present disclosure. In this design example, the CSI-RS resource(s) configured/provided by resourcesForUeInitiatedReporting configured/provided in the higher layer parameter CSI-AperiodicTriggerState could be common or different for the trigger/pre-notification message and the content in the (report-)type (C) based report.

For the (report-)type (C) specified herein in the present disclosure, wherein a report could contain/include a trigger/pre-notification message and a (corresponding) content (comprising one or more report quantities), the UE could follow one or more examples described herein to measure or not to measure the RS(s)—e.g., enabled for the UE-initiated/triggered reporting—for the trigger/pre-notification message and/or the content in the (report-)type (C) based report depending on one or more conditions, wherein the one or more conditions could be common or different for the trigger/pre-notification message and the content in the (report-)type (C) based report.

In another example, the condition(s) could correspond to network's configuration(s)/indication(s). For example, the UE could be configured/indicated by the network 130, e.g., via higher layer RRC signaling/parameter and/or MAC CE command and/or dynamic DCI based L1 signaling, not to measure any RSs or not to use/apply any measurement results for the trigger/pre-notification message and/or the content in the (report-)type (C) based UE-initiated/triggered report (i.e., follow one or more examples described herein). For another example, the UE could be configured/indicated by the network 130, e.g., via higher layer RRC signaling/parameter and/or MAC CE command and/or dynamic DCI based L1 signaling, to follow one or more examples described herein to measure the RS(s) that is (enabled) for the UE-initiated/triggered reporting for the trigger/Fpre-notification message and/or the content in the (report-)type (C) based report and use/apply the corresponding measurement result(s) to send the trigger/pre-notification message and/or the content in the (report-)type (C) based UE-initiated/triggered report.

For the (report-)type (C) specified herein in the present disclosure, wherein a report could contain/include a trigger/pre-notification message and a (corresponding) content (comprising one or more report quantities), the corresponding measurement RS(s) for the trigger/pre-notification message and/or the content could be with certain RS configuration(s)/setting(s), wherein the RS configuration(s)/setting(s) could be common or different for the trigger/pre-notification message and the content in the (report-)type (C) based report.

In one example, the RS configuration(s)/setting(s) could correspond to a (network) configured or fixed (or predefined) resource mapping for the corresponding measurement RS(s)—e.g., provided in/by CSI-RS-ResourceMapping. For example, for the trigger/pre-notification message in the (report-)type (C) based report, the higher layer parameter nrofPorts could be set to ‘p1’—i.e., one-port CSI-RS for measurement, while for the content in the (report-)type (C) based report, the higher layer parameter nrofPorts could be set to ‘p2’ or beyond—i.e., x-port CSI-RS for measurement, where x≥2.

In another example, the RS configuration(s)/setting(s) could identify/indicate a resource type, e.g., ‘aperiodic’, ‘semiPersistent’ or ‘periodic’, for the corresponding measurement RS(s).

In yet another example, the RS configuration(s)/setting(s) could identify/indicate a function for the corresponding measurement RS(s). For example, the RS configuration(s)/setting(s) for the trigger/pre-notification message in the (report-)type (C) based report could identify/indicate that the corresponding measurement RS(s) is CSI-RS(s) for tracking, while the RS configuration(s)/setting(s) for the content in the (report-)type (C) based report could identify/indicate that the corresponding measurement RS(s) is CSI-RS(s) for beam management or CSI-RS(s) for CSI acquisition.

Any of the above variation embodiments can be utilized independently or in combination with at least one other variation embodiment.

The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE), comprising:
a transceiver configured to:
receive first information to enable transmission of an indicator indicating transmission of a beam report,
transmit, based on the first information, the indicator, and
receive second information related to one or more channel state information reference signal (CSI-RS) resources for the beam report; and
a processor operably coupled with the transceiver, the processor configured to measure, based on the second information, the one or more CSI-RS resources for the beam report,
wherein the transceiver is further configured to transmit the beam report.

2. The UE of claim 1, wherein the first information corresponds to at least one of:
a higher layer radio resource control (RRC) parameter ueInitiatedReporting; and
a higher layer parameter reportQuantity provided by CSI-ReportConfig set to ‘none’.

3. The UE of claim 1, wherein:
the second information corresponds to at least one of:
a first configuration associated with a plurality of CSI-RS resources in a CSI resource set; and
a second configuration associated with a plurality of CSI-RS resource sets in a CSI resource setting, and
the CSI resource set comprises one or more CSI-RS resources.

4. The UE of claim 3, wherein:
the first configuration corresponds to:
a higher layer parameter csiResourceForUeInitiatedReporting set to ‘enabled’ for a first CSI-RS resource among the plurality of CSI-RS resources and the higher layer parameter csiResourceForUeInitiatedReporting set to ‘disabled’ for a second CSI-RS resource among the plurality of CSI-RS resources; or
a one-bit indicator corresponding to the first CSI-RS resource among the plurality of CSI-RS resources is set to ‘1’ and a one-bit indicator corresponding to the second CSI-RS resource among the plurality of CSI-RS resources is set to ‘0’; and
the beam report is transmitted based on the first CSI-RS resource.

5. The UE of claim 3, wherein:
the second configuration corresponds to:
a higher layer parameter csiResourceSetForUeInitiatedReporting set to ‘enabled’ for a first CSI-RS resource set among the plurality of CSI-RS resource sets and the higher layer parameter csiResourceSetForUeInitiatedReporting set to ‘disabled’ for a second CSI-RS resource set among the plurality of CSI-RS resource sets; or
a one-bit indicator corresponding to the first CSI-RS resource set among the plurality of CSI-RS resource sets is set to ‘1’ and a one-bit indicator corresponding to the second CSI-RS resource set among the plurality of CSI-RS resource sets is set to ‘0’, and
the beam report is transmitted based on the first CSI-RS resource set.

6. The UE of claim 1, wherein:
the transceiver is further configured to receive third information related to a CSI reporting setting for the beam report;
the processor is further configured to determine, based on the third information and the measurement, the beam report; and
the beam report includes one or more resource indicators and associated beam metrics.

7. The UE of claim 6, wherein the third information corresponds to at least one of:
a CSI reporting identity (ID);
a higher layer parameter csiReportForUeInitiatedReporting set to ‘enabled’; and
a one-bit flag indicator set to ‘1’.

8. The UE of claim 1, wherein the indicator and the beam report are transmitted in at least one of:
a same transmission via a same set of physical uplink control channel (PUCCH) or physical uplink shared channel (PUSCH) resources; and
different transmissions via different sets of PUCCH or PUSCH resources.

9. A base station (BS), comprising:
a processor; and
a transceiver operably coupled with the processor, the transceiver configured to:
transmit first information to enable transmission of an indicator indicating transmission of a beam report,
receive, based on the first information, the indicator,
transmit second information related to one or more channel state information reference signal (CSI-RS) resources for the beam report, and
receive the beam report, the beam report based on the one or more CSI-RS resources.

10. The BS of claim 9, wherein the first information corresponds to at least one of:
a higher layer radio resource control (RRC) parameter ueInitiatedReporting; and
a higher layer parameter reportQuantity provided by CSI-ReportConfig set to ‘none’.

11. The BS of claim 9, wherein:
the second information corresponds to at least one of:
a first configuration associated with a plurality of CSI-RS resources in a CSI resource set; and
a second configuration associated with a plurality of CSI-RS resource sets in a CSI resource setting, and
the CSI resource set comprises one or more CSI-RS resources.

12. The BS of claim 11, wherein:
the first configuration corresponds to:
a higher layer parameter csiResourceForUeInitiatedReporting set to ‘enabled’ for a first CSI-RS resource among the plurality of CSI-RS resources and the higher layer parameter csiResourceForUeInitiatedReporting set to ‘disabled’ for a second CSI-RS resource among the plurality of CSI-RS resources; or
a one-bit indicator corresponding to the first CSI-RS resource among the plurality of CSI-RS resources is set to ‘1’ and a one-bit indicator corresponding to the second CSI-RS resource among the plurality of CSI-RS resources is set to ‘0’; and
the beam report is based on the first CSI-RS resource.

13. The BS of claim 11, wherein:
the second configuration corresponds to:
a higher layer parameter csiResourceSetForUeInitiatedReporting set to ‘enabled’ for a first CSI-RS resource set among the plurality of CSI-RS resource sets and the higher layer parameter csiResourceSetForUeInitiatedReporting set to ‘disabled’ for a second CSI-RS resource set among the plurality of CSI-RS resource sets; or
a one-bit indicator corresponding to the first CSI-RS resource set among the plurality of CSI-RS resource sets is set to ‘1’ and a one-bit indicator corresponding to the second CSI-RS resource set among the plurality of CSI-RS resource sets is set to ‘0’, and
the beam report is based on the first CSI-RS resource set.

14. The BS of claim 9, wherein:
the transceiver is further configured to transmit third information related to a CSI reporting setting for the beam report;
the beam report includes one or more resource indicators and associated beam metrics; and
the beam report is based on the third information.

15. The BS of claim 14, wherein the third information corresponds to at least one of:
a CSI reporting identity (ID);
a higher layer parameter csiReportForUeInitiatedReporting set to ‘enabled’; and
a one-bit flag indicator set to ‘1’.

16. The BS of claim 9, wherein the indicator and the beam report are received in at least one of:
a same reception via a same set of physical uplink control channel (PUCCH) or physical uplink shared channel (PUSCH) resources; and
different receptions via different sets of PUCCH or PUSCH resources.

17. A method performed by a user equipment (UE), the method comprising:
receiving first information to enable transmission of an indicator indicating transmission of a beam report;
transmitting, based on the first information, the indicator;
receiving second information related to one or more channel state information reference signal (CSI-RS) resources for the beam report;
measuring, based on the second information, the one or more CSI-RS resources for the beam report; and
transmitting the beam report.

18. The method of claim 17, wherein the first information corresponds to at least one of:
a higher layer radio resource control (RRC) parameter ueInitiatedReporting; and
a higher layer parameter reportQuantity provided by CSI-ReportConfig set to ‘none’.

19. The method of claim 17, wherein:
the second information corresponds to at least one of:
a first configuration associated with a plurality of CSI-RS resources in a CSI resource set; and
a second configuration associated with a plurality of CSI-RS resource sets in a CSI resource setting, and
the CSI resource set comprises one or more CSI-RS resources.

20. The method of claim 19, wherein:
the first configuration corresponds to:
a higher layer parameter csiResourceForUeInitiatedReporting set to ‘enabled’ for a first CSI-RS resource among the plurality of CSI-RS resources and the higher layer parameter csiResourceForUeInitiatedReporting set to ‘disabled’ for a second CSI-RS resource among the plurality of CSI-RS resources; or
a one-bit indicator corresponding to the first CSI-RS resource among the plurality of CSI-RS resources is set to ‘1’ and a one-bit indicator corresponding to the second CSI-RS resource among the plurality of CSI-RS resources is set to ‘0’; and
the beam report is transmitted based on the first CSI-RS resource.
